(19) United States
(12) Patent Application Publication
(10) Pub. No.: US 2026/0046244 A1
(43) Pub. Date: Feb. 12, 2026

(54) MUP OVER MPLS

(71) Applicant: Arrcus Inc., San Jose, CA (US)

(72) Inventors: Keyur Patel, San Jose, CA (US); Tetsuya Murakami, San Jose, CA (US); Nalinaksh Pai, San Ramon, CA (US); Derek Man-Kit Yeung, Fremont, CA (US)

(21) Appl. No.: 19/216,078

(22) Filed: May 22, 2025

Related U.S. Application Data
(60) Provisional application No. 63/680,986, filed on Aug. 8, 2024.

(51) Int. Cl. H04L 45/50; H04L 12/46; H04L 12/66

(52) U.S. Cl. CPC H04L 45/50; H04L 12/4633; H04L 12/66

(57) ABSTRACT

Mobile User Plane (MUP) over Multi-Protocol Label Switching (MPLS) is implemented over an access an access network connecting a provider edge router to a gateway router, the gateway router being connected to a base station having a wireless connection to user equipment (UE). Traffic between the provider edge router and the gateway router is routed according to both of multi-protocol label switching (MPLS) protocol and mobile user plane (MUP) protocol. An MUP-controller may discover the UE, base station, and corresponding tunnel information and transmit this information to the provider edge router and gateway router, which then create an MPLS label and routing entries to implement MUP.

### RELATED APPLICATIONS

This application claims the benefit of U.S. Provisional Application Ser. No. 63/680,986, filed Aug. 8, 2024, and entitled “BGP MUP over MPLS Patent”. The foregoing application is hereby incorporated by reference in its entirety.

### FIELD OF THE INVENTION

This application relates to implementing mobile user plane (MUP) routing over a multi path label switching (MPLS) network.

### BACKGROUND

The Mobile User Plane (MUP) is a protocol for routing packets received from user equipment (UE) in a cellular communication network over an internet protocol (IP) network. MUP integrates with user plane function (UPF) for managing a connection to the UE and a subscription associated with the UE with routing of packets over an IP network.

It would be an advancement in the art to expand the capacity of networks to use MUP.

### BRIEF DESCRIPTION OF THE FIGURES

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of a network environment connected to a cellular communication network in accordance with an embodiment of the present invention;

FIG. 2 is a table illustrating the setup of a downstream connection and routing of downstream traffic using MUP over a multi-protocol label switching (MPLS) network in accordance with an embodiment of the present invention;

FIG. 3 is a table illustrating the setup of a downstream connection and routing of upstream traffic using MUP over a multi-protocol label switching (MPLS) network in accordance with an embodiment of the present invention;

FIG. 4 illustrates an example prefix segment identifier (SID) type length value (TLV) label in accordance with an embodiment of the present invention;

FIG. 5 is a table illustrating Per-Virtual Routing Function (VRF) processing in accordance with an embodiment of the present invention;

FIG. 6 is a table illustrating per-next hop processing in accordance with an embodiment of the present invention; and

FIG. 7 is a schematic block diagram of a computer system suitable for implementing methods in accordance with embodiments of the present invention.

### DETAILED DESCRIPTION

It will be readily understood that the components of the invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

Embodiments in accordance with the invention may be embodied as an apparatus, method, or computer program product. Accordingly, the invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the invention may be written in any combination of one or more programming languages, including an object-oriented programming language such as Java, Smalltalk, C++, or the like and conventional procedural programming languages, such as the “C” programming language or similar programming languages, and may also use descriptive or markup languages such as HTML, XML, JSON, and the like. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transitory computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

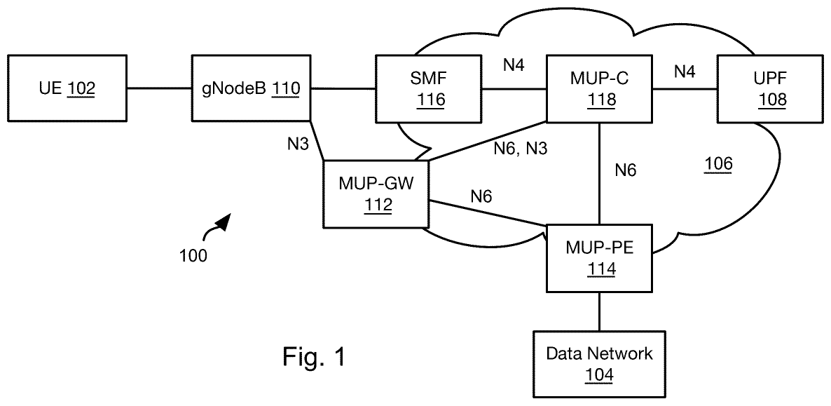

Referring to FIG. 1, the illustrated network environment 100 illustrates a connection between user equipment (UE) 102 and a data network 104, such as the Internet or other type of network, such as an internet protocol (IP) network. The UE 102 may connect to the data network 104 by way of an an access network (106). The access network 106 may further provide a connection between the UE 102 and a user plane function (UPF) 108 configured to manage a connection to the UE 102, including such things as quality of service (QoS), policy enforcement, and routing of traffic. The access network 106 may itself be an IP network and may further be a multi-protocol label switching (MPLS) network in the embodiments disclosed herein.

Using the approach described herein, the routing of data between the UE 102 and the data network 106 over the access network 106 is performed using mobile user plane (MUP) protocol. In particular, the approach described herein enables MUP to be implemented over an MPLS network.

MUP may be implemented using the illustrated components, each of which has the function ascribed therein according to the MUP protocol except as explicitly noted herein. The UE 102 may connect to the access network by way a base station, such as a gNodeB 110, which performs functions of receiving packets from the UE 102 by way of a radio antenna, encapsulating the packets into general packet radio service (GPRS) tunneling protocol (GTP) packets and forwarding the GTP packets to a MUP-enabled gateway 112 (MUP-GW 112) according to the approach described herein. The MUP-GW 112 may function as a gateway router and may be connected by the access network 106 to the data network 106 by a provider edge router 114 that is enabled to perform MUP (MUP-PE 114) according to the approach described herein.

In the illustrated embodiment, the gNodeB 110 is connected to the UPF 108 by way of a session management function (SMF) 116 for creating, deleting, and managing data sessions between the UE 102 and the UPF 108. Traffic to and from the UPF 108 may be routed by way of a controller, such as a MUP-enabled control node (MUP-C) 118. The MUP-C 118 may be a control plane node in the MUP architecture responsible for creating and managing the routes within an MUP enabled networks, such as the access network 106. The MUP-C 118 may provide an interface to get session information from the 5G Core Control Plane, such as from the UPF 108 or snooping traffic to and/or from the UPF 108, and converts the session information into routing information for the data plane nodes, such as in the form of BGP routes.

Routing of traffic among the illustrated components may be performed using virtual routing functions (VRF). These may include N3, N4, and N6 VRFs. The N3, N4, and N6 VRFs may be as defined according to any approach for implementing MUP known in the art. In the illustrated embodiment, the N3 VRF is a virtual routing function defining the routing of traffic between the gNodeB 110 and one or more MUP-GWs 112. The N4 VRF may define the routing of traffic among the SMF 116, MUP-C 118, and UPF 108. Routing of traffic among the MUP-GW 112, the MUP-PE 114, MUP-C 118 may be defined by the N6 VRF. The configuration of the N3 and N6 VRF may be managed by the MUP-C 118 as outlined in detail below.

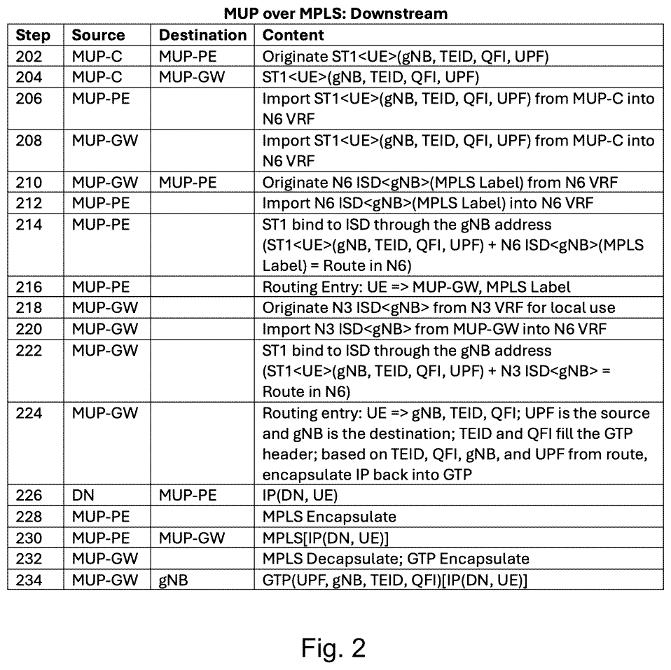

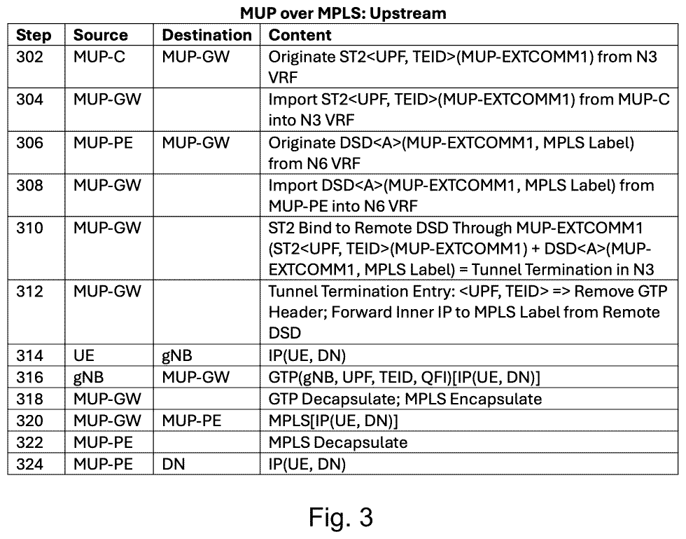

Referring to FIGS. 2 and 3, in cellular data communication networks that do not use MUP, gNodeB would transmit GTP packets to the UPF associated with a gateway. The UPF would then decapsulate the packets from GTP packets to IP packets and forward the IP packets to a gateway. MUP provides an improved approach that enables data packets to be transmitted to a gateway in bypass the UPF. Up to this point, MUP has not been available over some types of network, such as segment routing version 6 (SRv6) but not over multi-protocol label switching (MPLS) networks. In particular, MUP session information is not readily shared using SIDs in MPLS as in the case of SRv6, which provides an SID containing an Arg.Mob.Session, which carries information for encapsulating and decapsulating with respect to GTP (e.g., QFI, TEID, gNB). MPLS labels lack such a construct and are not large enough to include such information.

The approach described below enables the benefits of MUP to be achieved in MPLS networks.

The methods of FIGS. 2 and 3 may be proceeded by one or more discovery steps by MUP-GW 112, MUP-PE 114, and/or MUP-C 118 to generate constructs according to the MUP protocol (e.g., the MUP subsequent address family identifiers (MUP-SAFI or MUP-1)) as known in the art. For example, the MUP-GW 112 may perform internetwork segment discovery (ISD) to discover the address of gNodeB 110 (e.g. gNodeB prefix designated as gNB herein) and a segment identifier (SID) of a policy for performing GTP encapsulation and/or decapsulation (e.g., GTP 4/6.E SID), such as the locator for such an SID. The MUP-GW 112 may further configure the GTP 4/6.E locator on itself.

The methods of FIGS. 2 and 3 may be preceded by performing direct segment discovery (DSD) from MUP-GW 112 to MUP-PE 114 and/or vice versa. For example, DSD may be used to discover the data network 106, a DT4/6/46 or DX SID, an MUP-Extcomm, a DT 4/6 locator configured on MUP-GW or MUP-PE.

ISD and DSD may be performed according to any approach known in the art. GTP 4/6.E SID, DT4/6/46, DX SID, DT 4/6, and MUP-Extcomm may be as defined according to the MUP protocol, such as according to MUP-1.

The methods of FIGS. 2 and 3 may be preceded by using packet forwarding control protocol (PFCP) by the MUP-C 118 to determine reachability information for the UE 102, e.g., by snooping control traffic between the UE 102 and the UPF 108. For example, MUP-C 118 may discover type 1 session transformed (ST1) information, such as the address of the UE 102 (hereinafter “UE”), the gNodeB 110 address (“gNB”), the tunnel endpoint identifier (TEID) of a general packet radio service (GPRS) tunnel protocol (GTP) tunnel between gNodeB 110 and the UE 102, and quality of service flow identifier (QFI), and address of the UPF 108 (“UPF”). The MUP-C 118 may also discover type 2 session transformed (ST2) information, such as a GTP tunnel (e.g., UPF and TEID) and MUP Extcomm attached (“Extcomm”).

Although described in greater detail, the approach described below may implement the following two aspects. First, the MUP-PE 114 combines an ST1 from MUP-C 118 and an N6 ISD from MUP-GW 112 to create a forwarding entry in the N6 VRF and invoke forwarding of packets to the UE 102 using the MPLS label from the ISD. Second, the MUP-GW 112 combines an ST1 from MUP-C 118 and a local N3 ISD to create a forwarding entry to forward packets to gNodeB 110 using GTP encapsulation based on the QFI, TEID, and gNB (gNodeB 110 address) from the ST1. In addition, VRF N6 ISD from the MUP-GW 112 carries the MPLS label. In VRF N3, the ISD from MUP-GW 112 is local and the MPLS label is not relevant.

Referring specifically to FIG. 2, the illustrated method may be performed to enable MUP to be implemented over an access network 106 implementing MPLS. The method of FIG. 2 may include transmitting 202, to the MUP-PE 114, an ST1 message including the IP address of the UE 102 and the GTP tunnel information to the gNodeB 110 to which the UE 102 is connected, e.g., address of the gNodeB 110, the TEID, QFI, and address of the UPF 108. The ST1 message may also be transmitted 204 to the MUP-GW 112.

The MUP-PE 114 and MUP-GW 112 both import 206, 208 the information from the ST1 messages into the N6 VRF, e.g., routing tables managed by the MUP-PE 114 and MUP-GW 112 and associated with the N6 VRF. Following steps 206, 208 the MUP-PE 114 and MUP-GW 112 have an association between the IP address of the UE 102 and the GTP tunnel information.

The MUP-GW 112, which interfaces with the MPLS network implemented by the access network 106, may originate 210 internetwork segment discovery (ISD) message and transmit the ISD message to the MUP-PE 114. The ISD message may include the address of the gNodeB 110 and an MPLS label assigned to the gNodeB 110 address in the N6 VRF. The association between the address of the gNodeB 110 and the MPLS label may be created by the MUP-GW 112 in the N6 VRF.

Upon receiving the ISD message, the MUP-PE 114 imports 212 information from the ISD message into the N6 VRF, e.g., the address of the gNodeB 110 and the MPLS label. The MUP-PE 114 further binds 214 the ST1 to the ISD through the address of the gNodeB 110, e.g., the common gNodeB 110 address enables the information to be associated with one another to define a route. In particular, step 214 may include binding the VRF N6 ISD defined by the gNodeB 110 address and the MPLS label to the information in the ST1 message (UE 102 address, gNodeB 110 address, TEID, QFI, UPF 108 address) to create a route in VRF N6. This route may include an association between the UE 102 address and the MPLS label.

The MUP-PE 114 may further create 216 a routing entry, such as an entry defining a next hop for packets addressed to the UE 102 that references the MUP-GW (e.g., and IP address thereof) and the MPLS Label. The routing entry may therefore prompt the MUP-PE 114 to receive packets addressed by the UE 102, label the packets with the MPLS Label, and forward the packets to the MUP-GW over the access network 106.

The MUP-GW 112 may further define routing between itself and the gNodeB 110. For example, the MUP-GW 112 may originate 218 an ISD in VRF N3 that includes the address of gNodeB 110 for local use in routing packets from the MUP-GW 112 to the gNodeB 110. The MUP-GW 112 may import 220 the ISD from step 218 into the N6 VRF to define routing of packets received for N6 VRF to the N3 VRF. The MUP-GW may further bind 222 the ST1 information (UE 102 address, gNodeB 110 address, TEID, QFI, and UPF) to the N3 ISD of step 218 in the VRF N6 to define a route to gNodeB 110 in the N6 VRF for packets addressed to the UE 102.

The MUP-GW 112 may further define 224 a routing entry and other actions to perform in order to encapsulate packets address to the UE 102 address into GTP packets addressed to the gNodeB 110 address. For example, step 224 may include creating a routing entry mapping the UE 102 address to the gNodeB 110 address and other GTP information (e.g., TEID and QFI). The routing entry may specify using the UPF 108 address as a source and the gNodeB 110 address as a destination. The routing entry may specify a GTP header including the GTP information (TEID and QFI). The routing entry may instruct using the TEID, QFI, gNodeB 110 address, and UPF address to encapsulate an IP packet addressed to the UE 102 address into a GTP packet as defined above, e.g., having the UPF 108 address as the source, the gNodeB 110 address as the destination, and the GTP information in the header.

Following completion of step 226 the access network 106 is configured to route packets addressed to the UE 102 address over the access network 106 using MPLS and MUP. For example, the data network may transmit 226 an IP packet to the MUP-PE 114, the IP packet having a source address in the data network and the UE 102 address as the destination address. The MUP-PE receives the IP packet and encapsulates 228 the IP packet into an MPLS packet having the MPLS label based on the routing entry created at step 216, the MPLS label defining routing through the access network 106 to the MUP-GW 112. The MUP-PE 114 transmits 230 the MPLS packet to the MUP-GW 112. MUP-GW 112 decapsulates 232 the MPLS packet to obtain the IP packet and encapsulates the IP packet into a GTP packet using the routing entry created at step 224, the GTP packet being populated with information according to the routing entry as defined above (UPF 108 address as source address, gNodeB 110 address as destination address, and TEID and QFI in the header). The MUP-GW 112 then transmits 234 the packet to the gNodeB over the access network 106. The gNodeB 110 then forwards the GTP packet to the UE 102 using a cellular radio antenna.

FIG. 3 illustrates a method for creating an upstream connection for transmitting packets from the UE 102 to the data network 106 using MUP over MPLS. As for the method 200, the method of FIG. 3 may be proceeded by the MUP-C 118 receiving traffic directed to the UPF 108 or received from the UPF 108 that includes session information, such the IP address of the UE 102 and GTP tunnel information, such as address of the gNodeB 110 (gNB), tunnel end point identifier of the gNodeB 110 (TEID), quality of service flow identifier (QFI), and address of the UPF 108.

The method of FIG. 3 may include originating 302, by the MUP-C 118 a type 2 session transformed (ST2) message including the UPF 108 address and TEID, and an address in the data network 106 (“MUP-EXTCOMM1) and transmitting the ST2 message to the MUP-GW 112. The MUP-GW imports 304 the ST2 message into the N3 VRF.

The MUP-PE 114 may originate 306 a direct segment discovery (DSD) message from the N6 NRF, the DSD message labeled with a prefix “A” and referencing MUP-EXTCOMM1 and the MPLS label and transmitting the DSD message to the MUP-GW 112. The MUP-GW 112 then imports 308 the DSD message into the N6 VRF.

The MUP-GW may further bind 310 the data from the ST2 message to the data from the DSD Message using the data common between them, i.e., MUP-EXTCOMM1, in order to create a tunnel termination in the N3 VRF. The MUP-GW may create 312 a tunnel termination entry defining actions to perform in response to a GTP packet including the UPF 108 address and the TEID, specifically, to remove the GTP header, and forward the inner IP packet from the GTP packet after labeling the IP packet with the MPLS label.

Following step 312 the access network 106 is configured to route upstream traffic from the UE 102 to the data network 106. For example, the UE 102 may transmit 314 an IP packet to the gNodeB 110, the IP packet including the IP address of the UE 102 as the source address and an IP address in the data network 106 as the destination address. The gNodeB 110 encapsulates the IP packet into a GTP packet including a header including the gNodeB 110 address, UPF 108 address, TEID, and QFI. The gNodeB transmits 316 the GTP packet to the MUP-GW 112. The MUP-GW 112 decapsulates 318 the GTP packet to obtain the IP packet and encapsulates the IP packet into a MPLS packet labeled with the MPLS label using the tunnel termination entry from step 312. The MUP-GW 112 transmits the MPLS packet over the access network 106, which routes the packet to the MUP-PE 114 in response to the MPLS label. The MUP-PE decapsulates 322 the MPLS packet to obtain the IP packet and forwards 324 the packet over the data network 106 to the destination address of the IP packet.

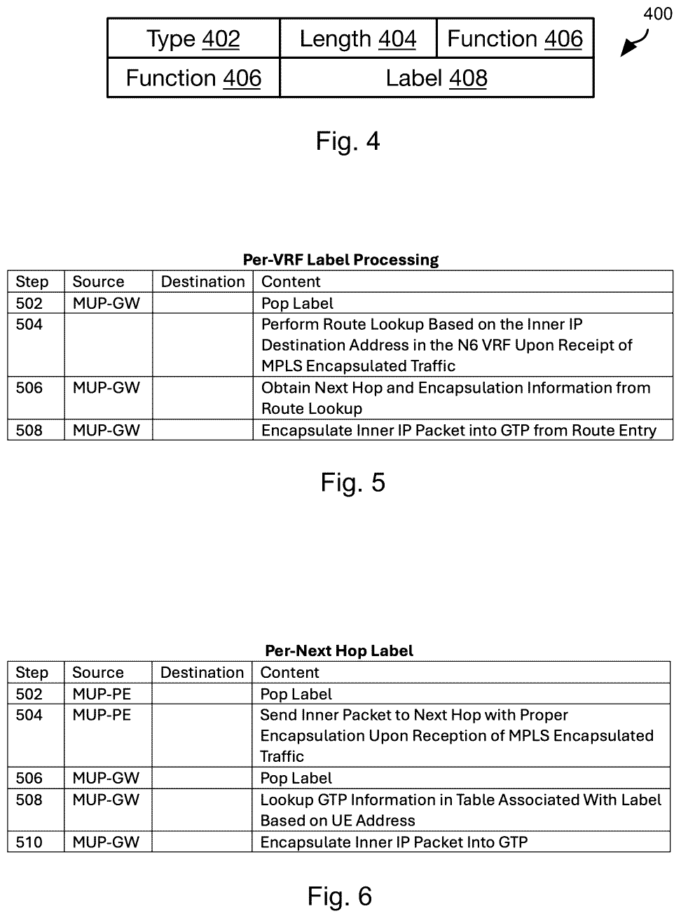

Referring to FIG. 4, illustrates an example segment identifier (SID) type length value (TLV) 400 (hereinafter “TLV 400”) that may be used to implement the ST1 and ST2 messages described above. The TLV 400 is an improvement over prior approaches for implementing TLVs. For example, the index-label TLV and segment routing global block (SRGB) TLV used in other approaches are intended for representing a segment routing SID, which is not applicable to the MPLS approach described above. The TLVs of these prior approaches take more space than is needed for the MPLS approach descried above, which requires only one absolute label (the UE 102 address and the UPF 108 address and TEID in the examples above). Prior approaches additionally don't include information to indicate which address family the label is for.

The illustrated TLV 400 includes a type field 402, a length field 404, and a function field 406, and a label field 408. The type field 402 indicates that the TLV 400 is of the illustrated type, such as type 7 as allocated by the Internet Assigned Numbers Authority (IANA). The length field 404 indicates the length of the TLV 400, such as 5 octets or other value. The function field 406 indicates the usage of the label, such for performing MUP over MPLS or any of the labels described above. The label field 408 carries the label communicated by the TLV 400 and may have a length, such as 3 octets. The label field 408 may carry the information conveyed by the TLV 400, such as the content of the ST1 and ST2 messages described above.

FIGS. 5 and 6 illustrate example processing of the TLV 400. For example, per-VRF label processing may be as shown in FIG. 5. In the method of FIG. 5, the MUP-GW 112 receives MPLS encapsulated traffic pops 502 the TLV 400. The TLV 400 directs the MUP-GW 112 to perform 504 a route lookup based on the inner IP packet destination address of the MPLS encapsulated traffic in the N6 VRF. The MUP-GW 112 then obtains 506 next hop and encapsulation information from the results of the route lookup of step 504. The MUP-GW 112. Then encapsulates 508 the inner IP packet into a GTP packet using the encapsulation information from step 506.

In the method of FIG. 6, the MUP-PE 114 pops 502 the label from a TLV 400, such as in an MPLS packet and sends 504 the inner packet to the next hop associated with the label with proper encapsulation, such as MPLS encapsulation according to the access network 106. The MU-GW 112 receives the packet from the MUP-PE 114 and pops 506 the label. The MUP-GW 112 performs 508 a lookup in a table to find GTP information associated with the label. The MUP-GW 112 then encapsulates the inner packet into a GTP packet using the GTP information.

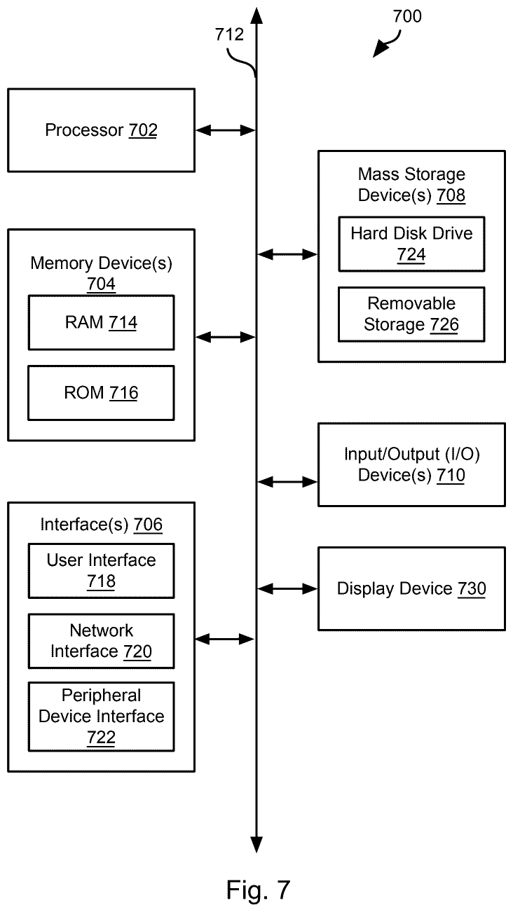

FIG. 7 is a block diagram illustrating an example computing device 700 which can be used to implement the system and methods disclosed herein, such as any of the UE 102, UPF 108, gNodeB 110, MUP-GW 112, MUP-PE 114, or an endpoint in the data network 104. Computing device 700 can function as a server, a client, or any other computing entity. Computing device can perform various functions as discussed herein, and can execute one or more application programs, such as the application programs described herein. Computing device 700 can be any of a wide variety of computing devices, such as a desktop computer, a notebook computer, a server computer, a handheld computer, tablet computer and the like.

Computing device 700 includes one or more processor(s) 702, one or more memory device(s) 704, one or more interface(s) 706, one or more mass storage device(s) 708, one or more Input/Output (I/O) device(s) 710, and a display device 730 all of which are coupled to a bus 712. Processor(s) 702 include one or more processors or controllers that execute instructions stored in memory device(s) 704 and/or mass storage device(s) 708. Processor(s) 702 may also include various types of computer-readable media, such as cache memory.

Memory device(s) 704 include various computer-readable media, such as volatile memory (e.g., random access memory (RAM) 714) and/or nonvolatile memory (e.g., read-only memory (ROM) 716). Memory device(s) 704 may also include rewritable ROM, such as Flash memory.

Mass storage device(s) 708 include various computer readable media, such as magnetic tapes, magnetic disks, optical disks, solid-state memory (e.g., Flash memory), and so forth. As shown in FIG. 7, a particular mass storage device is a hard disk drive 724. Various drives may also be included in mass storage device(s) 708 to enable reading from and/or writing to the various computer readable media. Mass storage device(s) 708 include removable media 726 and/or non-removable media.

I/O device(s) 710 include various devices that allow data and/or other information to be input to or retrieved from computing device 700. Example I/O device(s) 710 include cursor control devices, keyboards, keypads, microphones, monitors or other display devices, speakers, printers, network interface cards, modems, lenses, CCDs or other image capture devices, and the like.

Display device 730 includes any type of device capable of displaying information to one or more users of computing device 700. Examples of display device 730 include a monitor, display terminal, video projection device, and the like.

Interface(s) 706 include various interfaces that allow computing device 700 to interact with other systems, devices, or computing environments. Example interface(s) 706 include any number of different network interfaces 720, such as interfaces to local area networks (LANs), wide area networks (WANs), wireless networks, and the Internet. Other interface(s) include user interface 718 and peripheral device interface 722. The interface(s) 706 may also include one or more user interface elements 718. The interface(s) 706 may also include one or more peripheral interfaces such as interfaces for printers, pointing devices (mice, track pad, etc.), keyboards, and the like.

Bus 712 allows processor(s) 702, memory device(s) 704, interface(s) 706, mass storage device(s) 708, and I/O device(s) 710 to communicate with one another, as well as other devices or components coupled to bus 712. Bus 712 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 700, and are executed by processor(s) 702. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

1. A method comprising:
providing an access network connecting a provider edge router to a gateway router, the gateway router being connected to a base station having a wireless connection to user equipment (UE); and
routing traffic between the provider edge router and the gateway router according to both of multi-protocol label switching (MPLS) protocol and mobile user plane (MUP) protocol.

2. The method of claim 1, further comprising:
discovering, by a controller in a data path between the base station and a user plane function, general packet radio service (GPRS) tunneling protocol (GTP) information for the base station; and
transmitting, by the controller, the GTP information to the gateway router and to the provider edge router, the GTP information including an address of the base station and an address of the user equipment.

3. The method of claim 2, wherein the GTP information includes a tunnel endpoint identifier (TEID) and quality flow identifier (QFI).

4. The method of claim 2, wherein transmitting the GTP information to the gateway router and to the provider edge router comprises sending session transformed (ST) messages according to the MUP protocol.

5. The method of claim 2, wherein the GTP information includes a user plane function (UPF) address, the method further comprising creating, by the gateway router, a first routing entry associating the address of the user equipment with encapsulation using the GTP information with the UPF address as a source address and the address of the base station as a destination address.

6. The method of claim 5, further comprising:
generating, by the gateway router, an MPLS label associated with the address of the base station;
transmitting, by the gateway router, to the provider edge router, the MPLS label in association with the address of the base station; and
binding, by the provider edge router, the MPLS label with the GTP information using the address of the base station.

7. The method of claim 6, further comprising creating, by the provider edge router, a second routing entry associating the gateway router and the address of the user equipment with the MPLS label.

8. The method of claim 7, wherein binding the MPLS label, address of the base station, and GTP information comprises binding the MPLS label, address of the base station, and GTP information in a virtual routing function (VRF).

9. The method of claim 8, wherein the VRF is an N6 VRF according to the MUP protocol.

10. The method of claim 7, further comprising:
receiving, by the provider edge router, an internet protocol (IP) packet from a data network and addressed to the address of the user equipment;
encapsulating, by the provider edge router, the IP packet into an MPLS packet having the MPLS label according to the second routing entry; and
transmitting the MPLS packet to the gateway router.

11. The method of claim 10, further comprising:
receiving, by the gateway router, the MPLS packet;
decapsulating, by the gateway router, the MPLS packet to obtain the IP packet;
encapsulating, by the gateway router, the IP packet into a GTP packet using the first routing entry; and
transmitting, by the gateway router, the GTP packet to the base station.

12. A system comprising:
a provider edge router;
a base station configured to wirelessly connect to user equipment (UE);
a gateway router connected to the base station;
an access network connecting the provider edge router to the gateway router; and
a controller configured to configure the provider edge router and the gateway router to route traffic between the provider edge router and the gateway router according to both of multi-protocol label switching (MPLS) protocol and mobile user plane (MUP) protocol.

13. The system of claim 12, wherein the controller is configured to:
discover general packet radio service (GPRS) tunneling protocol (GTP) information for the base station; and
transmit the GTP information to the gateway router and to the provider edge router, the GTP information including an address of the base station and an address of the user equipment.

14. The system of claim 13, wherein the GTP information includes a tunnel endpoint identifier (TEID) and quality flow identifier (QFI).

15. The system of claim 13, wherein the controller is further configured to transmit the GTP information to the gateway router and to the provider edge router by sending session transformed (ST) messages according to the MUP protocol.

16. The system of claim 13, wherein the GTP information includes a user plane function (UPF) address and the gateway router is further configured to create a first routing entry associating the address of the user equipment with encapsulation using the GTP using the UPF address as a source address and the address of the base station as a destination address.

17. The system of claim 16, wherein:
the gateway router is configured to:
generate an MPLS label associated with the address of the base station; and
transmit, to the provider edge router, the MPLS label in association with the address of the base station; and
the provider edge router is configured to bind the MPLS label with the GTP information using the address of the base station.

18. The system of claim 17, wherein the provider edge router is further configured to create a second routing entry associating the gateway router and the address of the user equipment with the MPLS label.

19. The system of claim 18, wherein the provider edge router is configured to:
receive an internet protocol (IP) packet from a data network and addressed to the address of the user equipment;
encapsulate the IP packet into an MPLS packet having the MPLS label according to the second routing entry; and
transmit the MPLS packet to the gateway router.

20. The system of claim 19, wherein the gateway router is configured to:
receive the MPLS packet;
decapsulate the MPLS packet to obtain the IP packet;
encapsulate the IP packet into a GTP packet using the first routing entry; and
transmit the GTP packet to the base station.
